(19) United States
(12) Patent Application Publication
(10) Pub. No.: US 2010/0110319 A1
(43) Pub. Date: May 6, 2010

(54) Pixel circuit and driving method thereof

(76) Inventors: Pei-Yi Chen, Hsin-Chu (TW); Hsueh-Ying Huang, Hsin-Chu (TW); Chih-Yuan Chien, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/507,802

(22) Filed: Jul. 23, 2009

(30) Foreign Application Priority Data
Nov. 6, 2008 (TW) 097142841

(51) Int. Cl. G02F 1/1343; G09G 5/00

(52) U.S. Cl. 349/38; 345/205

(57) ABSTRACT

Pixel circuit includes first and second scan lines, data line, three switches, and pixel. Three switches all include first end, second end, and control end. Pixel includes first and second sub-pixels. First end of first switch is coupled to data line. Control end of first switch is coupled to first scan line. First end of second switch is coupled to second end of first switch. Control end of second switch is coupled to second scan line. First end of third switch is coupled to data line. Control end of third switch is coupled to first scan line. First sub-pixel is coupled to second end of second switch for coupling to second end of third switch through second and first switches. Second sub-pixel is coupled to second end of third switch for coupling to data line through third switch.

### BACKGROUND OF THE INVENTION

1. Field of the Invention

The present invention relates to a pixel circuit and driving method thereof, and more particularly, to a pixel circuit and driving method thereof capable of improving the color washout phenomenon.

2. Description of the Prior Art

Since the Liquid Crystal Display (LCD) has the advantage of the smaller size, the lower power consumption and no radiance, the LCD is becoming the main stream of the market gradually. However, the desire of the LCD with the wider viewing angle, the higher resolution and the larger size is the market trend.

However, when watching the LCD from a large viewing angle, the color washout phenomenon is generated so that the color of the image is distorted. The so-called color washout phenomenon means that when watching the LCD from a larger viewing angle, the color of the image is distorted to be whiter than normal. That is, when watching the LCD from a larger viewing angle, the distortion for the pixels with the medium and low gray-level luminance is more serious. As a result, reducing the redundant luminance can effectively improve the color washout phenomenon. Therefore, because of the trend of the image without distortion, the development of the wide viewing angle technology is necessary.

### SUMMARY OF THE INVENTION

The present invention provides a pixel circuit. The pixel circuit comprises a first scan line, a second line, a data line, a first pixel switch, a second pixel switch, a third pixel switch, and a pixel. The first pixel switch comprises a first end, coupled to the data line, a second end, and a control end, coupled to the second scan line. The second pixel switch comprises a first end, coupled to the second end of the first pixel switch, a second end, and a control end, coupled to the first scan line. The third pixel switch comprises a first end, coupled to the data line, a second end, and a control end, coupled to the first scan line. The pixel comprises a first sub-pixel and a second sub-pixel. The first sub-pixel is coupled to the second end of the second pixel switch for coupling to the data line through the first pixel switch and the second pixel switch. The second sub-pixel is coupled to the second end of the third pixel switch for coupling to the data line through the third pixel switch.

The present invention further provides a pixel circuit. The pixel circuit comprises a first scan line, a second scan line, a data line, a first pixel switch, a second pixel switch, a third pixel switch, and a pixel. The first pixel switch comprises a first end, a second end, and a control end, coupled to the second scan line. The second pixel switch comprises a first end, coupled to the second end of the first pixel switch, a second end, coupled to the data line, and a control end, coupled to the first scan line. The third pixel switch comprises a first end, coupled to the data line, a second end, and a control end, coupled to the first scan line. The pixel comprises a first sub-pixel and a second sub-pixel. The first sub-pixel is coupled to the first end of the first pixel switch for coupling to the data line through the second pixel switch and the first pixel switch. The second sub-pixel is coupled to the second end of the third pixel switch for coupling to the data line through the third pixel switch.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the LCD according to a first embodiment of the present invention.

FIG. 2 is a diagram illustrating the equivalent circuit of the LCD according to the first embodiment of the present invention.

FIG. 3 is a diagram illustrating the driving principle of the LCD.

FIG. 4 is a diagram illustrating the LCD according to a second embodiment of the present invention.

FIG. 5 is a diagram illustrating the equivalent circuit of the LCD according to the second embodiment of the present invention.

### DETAILED DESCRIPTION

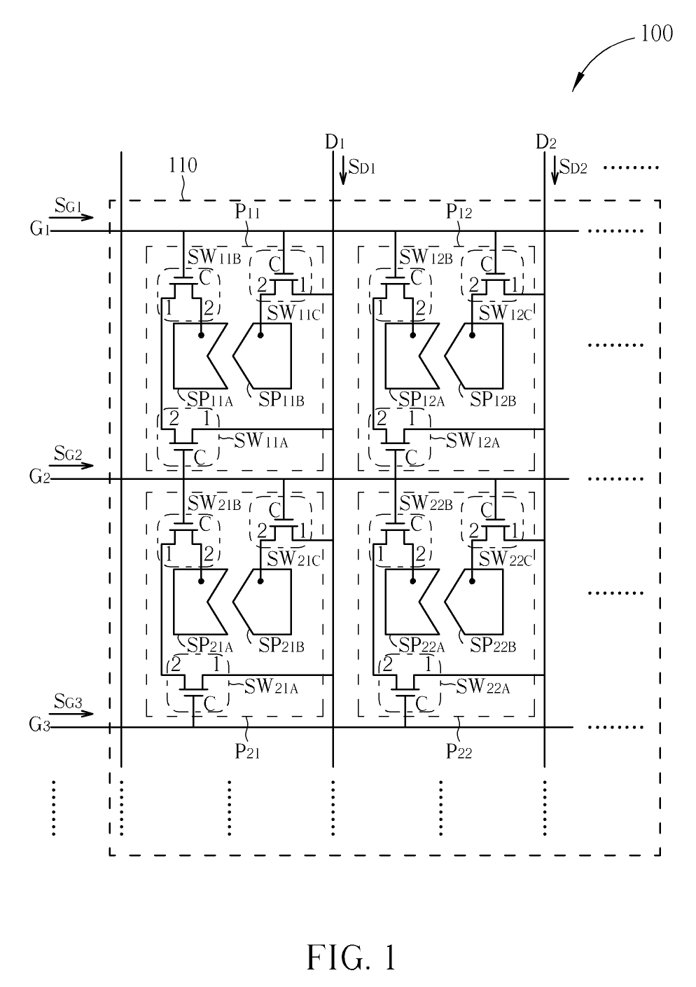

Please refer to FIG. 1. FIG. 1 is a diagram illustrating the LCD 100 according to a first embodiment of the present invention. The LCD 100 comprises a plurality of data lines, for example, D₁, and D₂, and a plurality of scan lines, for example, G₁, G₂ and G₃. The scan lines G₁, G₂, G₃ and so on are orientated to a first direction (the horizontal direction) and are approximately arranged in parallel with each other. The data lines D₁, D₂, and so on are orientated to a second direction (vertical direction) and are approximately arranged in parallel with each other.

The LCD 100 is divided into a plurality of display areas by the scan lines G₁, G₂, G₃ and so on, and the data lines D₁, D₂, D₃ and so on. The display areas are arranged in an array. In each display area, a pixel P is disposed, for example, the pixels P₁₁, P₁₂, P₂₁ and P₂₂. In this way, a pixel array (pixel circuit) 110 is formed on the LCD 100. In one preferred embodiment, each pixel is divided into at least a first sub-pixel and a second sub-pixel. For example, the pixel P₁₁ is divided into a first sub-pixel SP_{11A} and a second sub-pixel SP_{11B}. In the present embodiment, the first sub-pixels of the pixels of the M^{th} row in the horizontal direction are all coupled to the M^{th} scan line G_{M} and the (M+1)^{th} scan line G_{M+1}, and the second sub-pixels of the M^{th} row in the horizontal direction are all coupled to the M^{th} scan line G_{M}. In addition, the first sub-pixel and the second sub-pixel of the pixels of the N^{th} column in the vertical direction receive the data signal S_{D} transmitted from the data line D_{N}, wherein both M and N are positive integers.

Each pixel comprises a first sub-pixel, a second sub-pixel, a first pixel switch, a second pixel switch and a third pixel switch. The first sub-pixel is coupled through the first and the second pixel switches to the corresponding scan lines and the corresponding data line. The second sub-pixel is coupled through the third pixel switch to the corresponding scan line and the corresponding data line. For instance, the pixel P₁₁ comprises a first sub-pixel SP_{11A}, a second sub-pixel SP_{11B}, a first pixel switch SW_{11A}, a second pixel switch SW_{11B} and a third pixel switch SW_{11C}. Each pixel switch comprises a first end, a second end and a control end. Each pixel switch, according to the voltage level of the control end of the pixel switch, couples the first end of the pixel switch to the second end of the pixel switch. More precisely, when the voltage on the control end of a pixel is at a high voltage level, the pixel switch is turned on. That is, the first end 1 of the pixel switch is coupled to the second end 2 of the pixel switch. In the pixel P₁₁, the control end C of the first pixel switch SW_{11A} is coupled to the scan line G₂ for receiving the scan signal S_{G2}, the first end 1 of the first pixel switch SW_{11A} is coupled to the data line D₁, and the second end 2 of the first pixel switch SW_{11A} is coupled to the first end 1 of the second pixel switch SW_{11B}; the control end C of the second pixel switch SW_{11B} is coupled to the scan line G₁ for receiving the scan signal S_{G1}, the first end 1 of the second pixel switch SW_{11B} is coupled to the second end 2 of the first pixel switch SW_{11A}, and the second end 2 of the second pixel switch SW_{11B} is coupled to the first sub-pixel SP_{11A}; the control end C of the third pixel switch SW_{11C} is coupled to the scan line G₁ for receiving the scan signal S_{G1}, the first end 1 of the third pixel switch SW_{11C} is coupled to the data line D₁, and the second end 2 of the third pixel switch SW_{11C} is coupled to the second sub-pixel SP_{11B}. By means of this design, when the LCD 100 displays the image, the first sub-pixel SP_{11A} and the second sub-pixel SP_{11B} of the pixel P₁₁ have the luminance with different gray level so as to solve the problem related to the color washout phenomenon. The related operational principle is described in detail hereinafter. The structures of the rest pixels are similar to the pixel P₁₁ and hereinafter will not be repeated again for brevity.

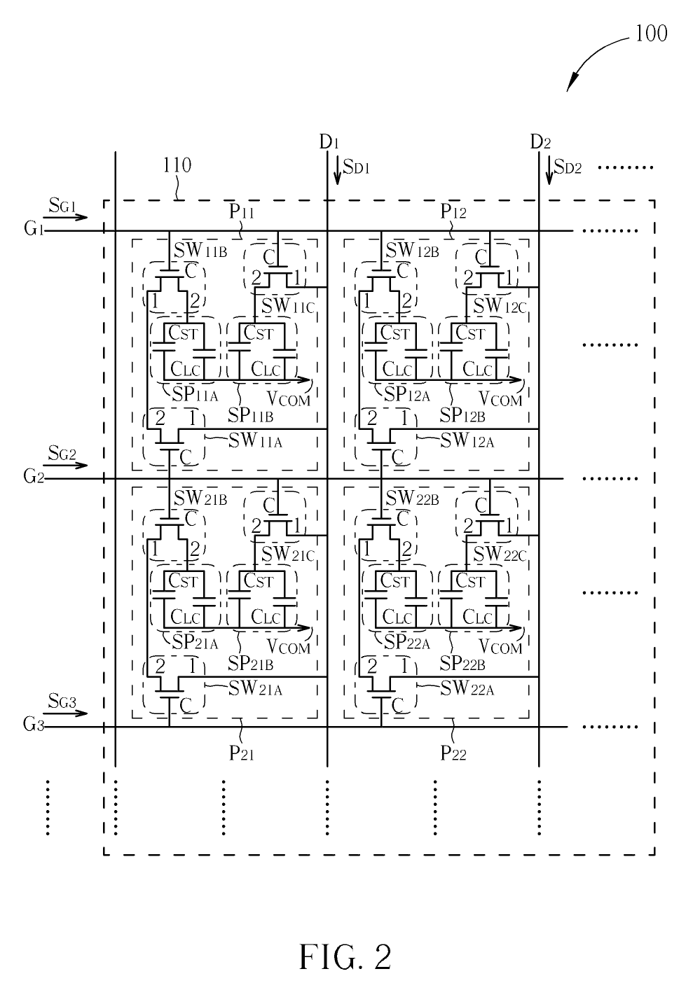

Please refer to FIG. 2. FIG. 2 is a diagram illustrating the equivalent circuit of the LCD according to the first embodiment of the present invention. As shown in FIG. 2, each sub-pixel comprises a liquid crystal capacitor and a storage capacitor. For instance, in the pixel P₁₁, the first sub-pixel SP_{11A} comprises a liquid crystal capacitor C_{LC} and a storage capacitor C_{ST}. The capacitors C_{LC} and C_{ST} are connected in parallel with each other between the second end 2 of the pixel switch SW_{11B} and a common end V_{COM}. The common end V_{COM} is utilized for providing a common voltage V_{COM}. The second sub-pixel SP_{11B} comprises a liquid crystal capacitor C_{LC} and a storage capacitor C_{ST}. The capacitors C_{LC} and C_{ST} are connected in parallel with each other between the second end 2 of the pixel switch SW_{11C} and a common end V_{COM}. The structures of the rest pixels are similar to the pixel P₁₁ and hereinafter will not be repeated again for brevity.

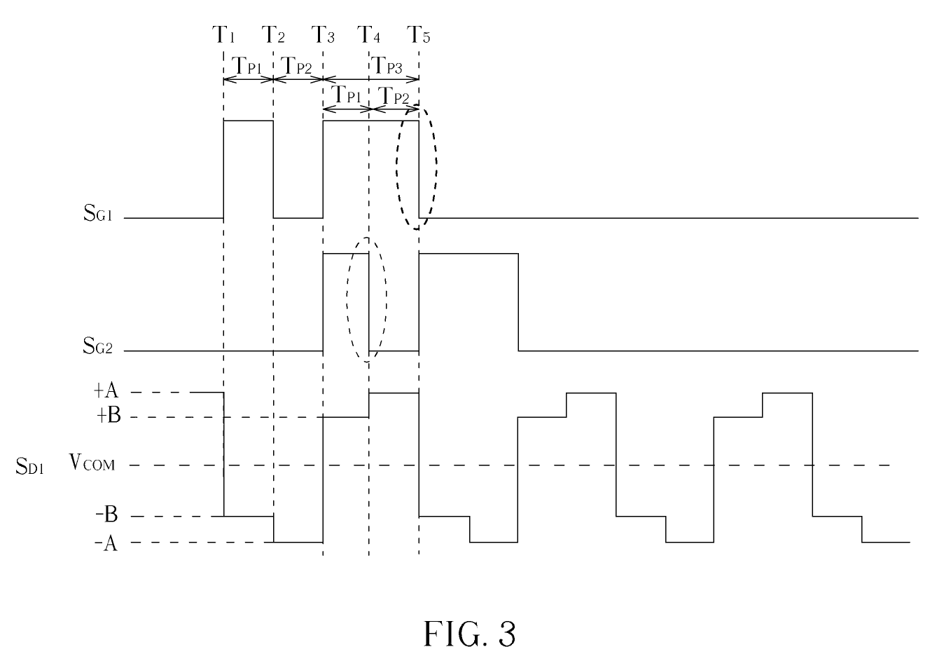

Pleas refer to FIG. 3. FIG. 3 is a timing diagram illustrating the principle for driving the LCD 100. In FIG. 3, only the pixel P₁₁ is illustrated as an example and the driving method of the rest pixels is similar to the pixel P₁₁. In the LCD 100, when a pixel is driven, the corresponding scan signal (means the voltage on the corresponding scan line) is raised up to a high voltage level and keeps for a predetermined period T_{P1}, and then the corresponding scan signal is lowered down to a low voltage level and keeps for a predetermined period T_{P2}. Then the corresponding scan signal is raised up again to the high voltage level and keeps for a predetermined period T_{P3}. The length of the predetermined period T_{P3} is the sum of the predetermined periods T_{P1} and T_{P2}. As shown in FIG. 3, at the moment T₃, the scan signal S_{G1} is raised up to the high voltage level and keeps for the predetermined period T_{P3} (means to keep until the moment T₅) and the scan signal S_{G2} is raised up to the high voltage level and keeps for a predetermined period T_{P1} (means to keep until the moment T₄). In this way, between the moment T₃ and the moment T₄, The pixel switches SW_{11A}, SW_{11B}, SW_{11C}, SW_{21A} and the SW_{21B} are all turned on so that the data signal S_{D1} transmits the data +B through the data line D₁, the pixel switch _{SW11A} and the pixel switch SW_{11B} to the first sub-pixel SP_{11A} and through the data line D₁ and the pixel switch SW_{11C} to the second sub-pixel SP_{11B}. Between the moment T₄ and the moment T₅, the scan signal S_{G1} still keeps at a high voltage level, but the scan signal S_{G2} is lowered down to a low voltage level so that the pixel switch SW_{11A} is turned off and the pixel switches SW_{11B} and SW_{11C} still keep turned on. Since the pixel switch SW_{11A} is turned off, the data signal S_{D1} can not transmit the data +A to the first sub-pixel SP_{11A} (even though the pixel switch SW_{11B} is still turned on). The data signal S_{D1} still transmits the data +A through the data line D₁ and the pixel switch SW_{11C} to the second sub-pixel SP_{11B}. That is, the data stored in the second sub-pixel SW_{11B} is updated to be the data +A. In other words, both the pixel switches SW_{11A} and SW_{11B} have to be turned on for coupling the first sub-pixel SP_{11A} to the data line D₁ so as to receive the data signal S_{D1}, but only the pixel switch SW_{11C} has to be turned on for coupling the second sub-pixel SP_{11B} to the data line D₁ so as to receive the data signal S_{D1}. In this way, the second sub-pixel SP_{11B} is charged up to the voltage level of the data +B first and is then further raised up to the voltage level of the data +A so that the second sub-pixel SP_{11B} can be more precisely charged up to the voltage level of the data +A. In this way, after driving by the scan signals S_{G1} and S_{G2}, the first sub-pixel SP_{11A} and the second sub-pixel SP_{11B} have different data (means to have different gray levels and different luminance) so as to reduce the color washout phenomenon.

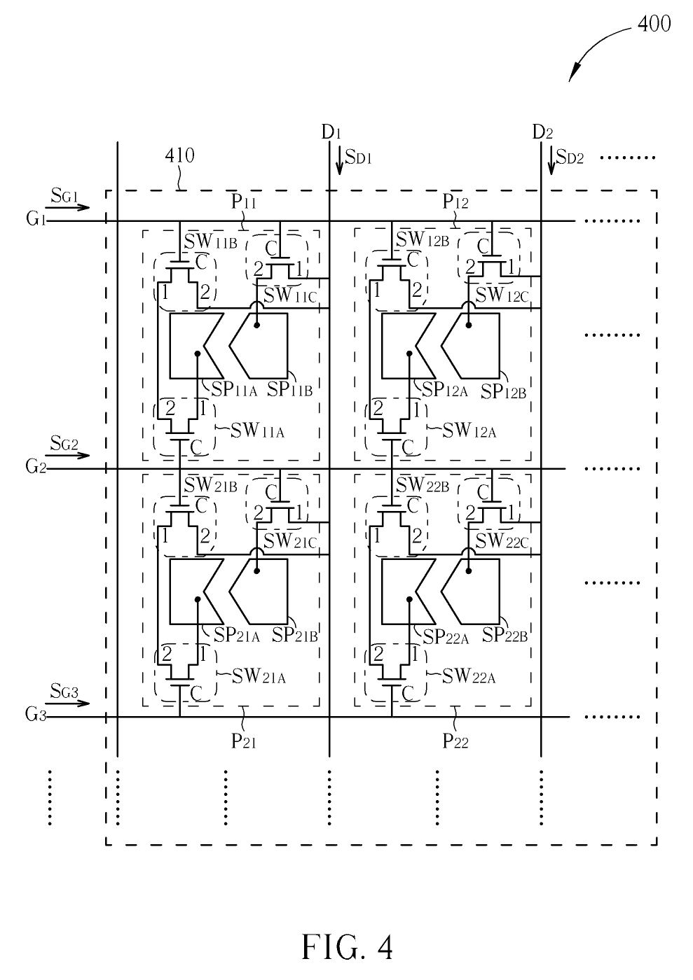

Please refer to FIG. 4. FIG. 4 is a diagram illustrating the LCD 400 according to a second embodiment of the present invention. The LCD 400 is similar to the LCD 100. The difference between the LCDs 100 and 400 is that the coupling relation between the pixel switches of the pixels of the pixel array 410 is different from that between the pixel switches of the pixels of the pixel array 110. The detailed coupling relation is described hereinafter.

For instance, in the pixel array 410, the pixel P₁₁ comprises a first sub-pixel SP_{11A}, a second sub-pixel SP_{11B}, a first pixel switch SW_{11A}, a second pixel switch SW_{11B} and a third pixel switch SW_{11C}. In the pixel P₁₁, the control end C of the first pixel switch SW_{11A} is coupled to the scan line G₂ for receiving the scan signal S_{G2}; the first end 1 of the first pixel switch SW_{11A} is coupled to the first sub-pixel SP_{11A}; the second end 2 of the first pixel switch SW_{11A} is coupled to the first end 1 of the second pixel switch SW_{11B}. The control end C of the second pixel switch SW_{11B} is coupled to the scan line G₁ for receiving the scan signal S_{G1}; the first end 1 of the second pixel switch SW_{11B} is coupled to the second end 2 of the first pixel switch SW_{11A}; the second end 2 of the second pixel switch SW_{11B} is coupled to the data line D₁. The control end C of the third pixel switch SW_{11C} is coupled to the scan line G₁ for receiving the scan signal S_{G1}; the first end 1 of the third pixel switch SW_{11C} is coupled to the data line D₁; the second end 2 is coupled to the second sub-pixel SP_{11B}. By means of such design, when the LCD 400 displays the image, the first sub-pixel SP_{11A} and second sub-pixel SP_{11B} have the luminance with different gray level so as to solve the problem related to the color washout phenomenon. The related operational principle is described in detail hereinbefore. The structures of the rest pixels are similar to the pixel P₁₁ and hereinafter will not be repeated again for brevity.

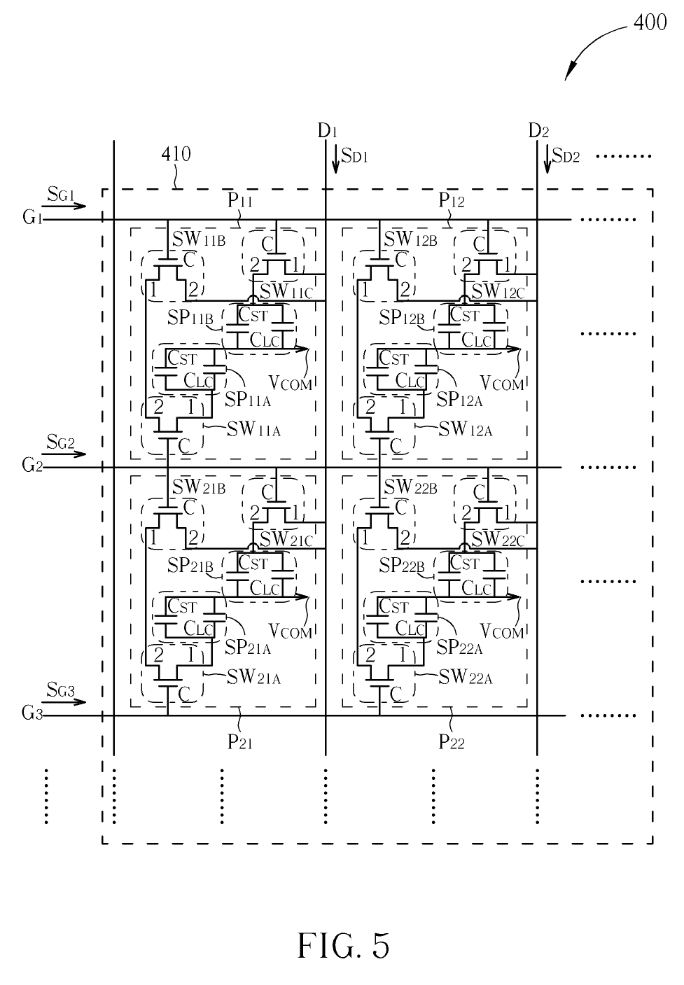

Please refer to FIG. 5. FIG. 5 is a diagram illustrating the equivalent circuit of the LCD 400 according to the second embodiment of the present invention. As shown in FIG. 5, each sub-pixel comprises a liquid crystal capacitor and a storage capacitor. For instance, in the pixel P₁₁, the first sub-pixel SP_{11A} comprises a liquid crystal capacitor C_{LC} and a storage capacitor C_{ST}. The capacitors C_{LC} and C_{ST} are connected in parallel with each other between the first end 1 of the pixel switch SW_{11A} and a common end V_{COM}. The common end V_{COM} is utilized for providing a common voltage V_{COM}. The second sub-pixel SP_{11B} comprises a liquid crystal capacitor C_{LC} and a storage capacitor C_{ST}. The capacitors C_{LC} and C_{ST} are connected in parallel between the second end 2 of the pixel switch SW_{11C} and the common end V_{COM}. The structures of the rest pixels are similar to the pixel P₁₁ and hereinafter will not be repeated again for brevity.

In conclusion, by means of the pixel array (pixel circuit) provided by the present invention, the different data are effectively transmitted to the different sub-pixels of a pixel so that the different sub-pixels of the pixel have the luminance with different gray level so as to reduce the color washout phenomenon, causing a great convenience.

Those skilled in the art will readily observe that numerous modifications and alterations of the device and method may be made while retaining the teachings of the invention.

What is claimed is:

1. A pixel circuit, comprising:
a first scan line;
a second scan line,
a data line;
a first pixel switch, comprising:
a first end, coupled to the data line;
a second end; and
a control end, coupled to the second scan line;
a second pixel switch, comprising:
a first end, coupled to the second end of the first pixel switch;
a second end; and
a control end, coupled to the first scan line;
a third pixel switch, comprising:
a first end, coupled to the data line;
a second end; and
a control end, coupled to the first scan line; and
a pixel, comprising:
a first sub-pixel, coupled to the second end of the second pixel switch for coupling to the data line through the first pixel switch and the second pixel switch; and
a second sub-pixel, coupled to the second end of the third pixel switch for coupling to the data line through the third pixel switch.

2. The pixel circuit of claim 1, wherein:
the first sub-pixel comprises:
a liquid crystal capacitor, coupled between the second end of the second pixel switch and a common end; and
a storage capacitor, coupled between the second end of the second pixel switch and the common end; and
the second sub-pixel comprises:
a liquid crystal capacitor, coupled between the second end of the third pixel switch and the common end; and
a storage capacitor, coupled between the second end of the third pixel switch and the common end.

3. The pixel circuit of claim 1, wherein when a first scan signal of the first scan line controls the second pixel switch to turn on and a second scan signal of the second scan line controls the first pixel switch to turn on, the first sub-pixel receives a signal from the data line.

4. The pixel circuit of claim 1, wherein when a first scan signal of the first scan line controls the third pixel switch to turn on, the second sub-pixel receives a signal from the data line.

5. A driving method for the pixel circuit of the claim 1, comprising:
at a first moment, driving the first scan line for turning on the second pixel switch and the third pixel switch for a first predetermined period;
at the first moment, driving the second scan line for turning on the first pixel switch for a second predetermined period;
wherein the second predetermined period is shorter than the first predetermined period;
wherein the difference between the first predetermined period and the second predetermined period is a third predetermined period;
during the second predetermined period, providing a first data to the first and the second sub-pixels through the first pixel switch and the third pixel switch, respectively; and
during the third predetermined period, providing a second data to the second sub-pixel through the third pixel switch.

6. A pixel circuit, comprising:
a first scan line;
a second scan line;
a data line;
a first pixel switch, comprising:
a first end;
a second end; and
a control end, coupled to the second scan line;
a second pixel switch, comprising:
a first end, coupled to the second end of the first pixel switch;
a second end, coupled to the data line; and
a control end, coupled to the first scan line;
a third pixel switch, comprising:
a first end, coupled to the data line;
a second end; and
a control end; coupled to the first scan line; and
a pixel, comprising:
a first sub-pixel, coupled to the first end of the first pixel switch for coupling to the data line through the second pixel switch and the first pixel switch; and
a second sub-pixel, coupled to the second end of the third pixel switch for coupling to the data line through the third pixel switch.

7. The pixel circuit of the claim 6, wherein:
the first sub-pixel comprises:
a liquid crystal capacitor, coupled between the first end of the first pixel switch and a common end; and
a storage capacitor, coupled between the first end of the first pixel switch and the common end; and
the second sub-pixel comprises:
a liquid crystal capacitor, coupled between the second end of the third pixel switch and the common end; and
a storage capacitor, coupled between the second end of the third pixel switch and the common end.

8. The pixel circuit of the claim 7, wherein when a first scan signal of the first scan line controls the second pixel switch to turn on and a second scan signal of the second scan line controls the first pixel switch to turn on, the first sub-pixel receives a signal from the data line.

9. The pixel circuit of claim 7, wherein when a first scan signal of the first scan line controls the third pixel switch to turn on, the second sub-pixel receives a signal from the data line.
